(19) United States
(12) Patent Application Publication
(10) Pub. No.: US 2018/0013870 A1
(43) Pub. Date: Jan. 11, 2018

(54) VOLUME ADJUSTMENT METHOD AND COMMUNICATION DEVICE USING THE SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: YUNG-CHANG HUANG, New Taipei (TW)

(21) Appl. No.: 15/203,805

(22) Filed: Jul. 7, 2016

(51) Int. Cl. H04M 1/60

(52) U.S. Cl. CPC H04M 1/60

(57) ABSTRACT

A volume adjustment method is executed in a first communication device while in communication with a second communication device. The first communication device monitors received volume level of second communication device and determines whether the received volume is within or outside a reference volume range, the range being activated from a range of reference volumes. If the volume is out of the reference volume range, the first communication device transmits volume adjustment information to the second communication device, so as to adjust the received volume of the second communication device.

### FIELD

The subject matter herein generally relates to telephony communications.

### BACKGROUND

When calling a remote user via a phone, a user may increase volume of the phone using a functional key when voice of the remote user sounds low. However, noises are generated if the volume of the phone is increased. In addition, even if the volume is increased to the maximum, the user may still be unable to clearly hear the voice of the remote user.

### BRIEF DESCRIPTION OF THE DRAWINGS

Implementations of the present technology will now be described, by way of example only, with reference to the attached figures.

FIG. 1 illustrates a diagrammatic view of one embodiment of a communication environment of two communication devices.

FIG. 2 illustrates a block diagram of one embodiment of functional modules of one of the two communication devices of FIG. 1.

FIG. 3 illustrates a flowchart of one embodiment of a volume adjustment method.

FIG. 4 illustrates a flowchart of another embodiment of a volume adjustment method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

It should be noted that references to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

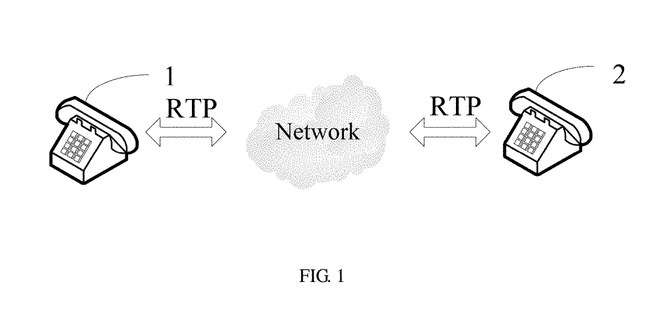

FIG. 1 illustrates a diagrammatic view of one embodiment of a communication environment for at least two communication devices, for example, a first communication device 1 and a second communication device 2. In this embodiment, the first communication device 1 may transmit voice to the second communication device 2 based on a Real-time Transport Protocol (RTP), and transmit volume adjustment information to the second communication device 2 via Session Initiation Protocol/Session Description Protocol (SIP/SDP) multi-media attribute. In one embodiment, the first communication device 1 may also transmit the volume adjustment information or alarm information to the second communication device 2 by other ways.

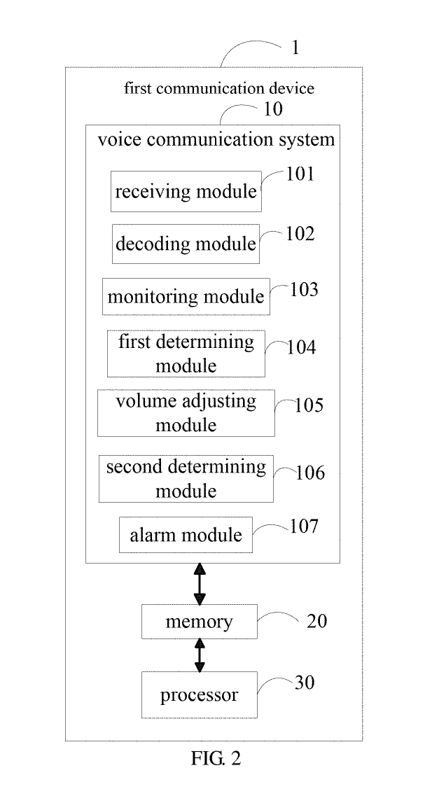

FIG. 2 illustrates one embodiment of functional modules of the first communication device 1. The first communication device 1 includes a voice communication system 10, a memory 20, and a processor 30. The voice communication system 10 includes a receiving module 101, a decoding module 102, a monitoring module 103, a first determining module 104, a volume adjusting module 105, a second determining module 106, and an alarm module 107.

The receiving module 101 receives an input instruction from a user.

The decoding module 102 decodes the input instruction, and activates one of a plurality of volume ranges as a reference volume range according to the decoded input instruction.

The monitoring module 103 monitors volume of the second communication device 2 when the first communication device 1 is communicating with the second communication device 2.

The first determining module 104 determines whether the volume of the second communication device 2 is out of the activated reference volume range.

The volume adjusting module 105 transmits volume adjustment information to the second communication device 2 when the volume of the second communication device 2 is out of the activated reference volume range, so as to adjust the volume of the second communication device 2.

The second determining module 106 determines within a preset time whether the volume of the second communication device 2 is adjusted after the volume adjustment information is transmitted to the second communication device 2 by the first communication device 1.

The alarm module 107 transmits alarm information to the second communication device 2 when the first communication device 1 does not receive feedback information from the second communication device 2 within the preset time after the first communication device 1 transmits the volume adjustment information to the second communication device 2.

The modules 101-107 are configured to be executed by one or more processors 30. Each module of the present disclosure is a computer program segment to complete a specific function. A memory 20 storages the program code and other information of the voice communication system 10.

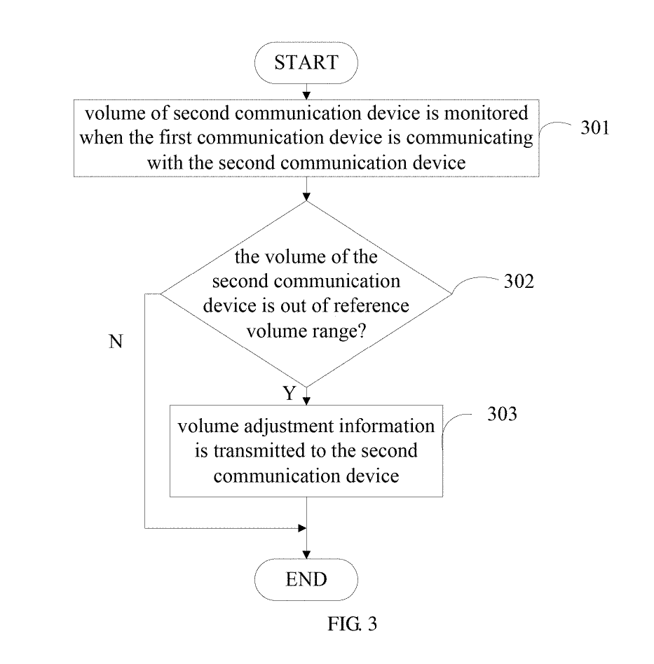

FIG. 3 illustrates a flowchart of an embodiment of the volume adjustment method. The execution of the method may be carried out by, but is not limited to, the first communication device 1.

At block 301, volume of a second communication device 2 is monitored when the first communication device 1 is communicating with the second communication device 2.

At block 302, a determination is made as to whether the volume of the second communication device 2 is beyond the activated reference volume range. A plurality of volume ranges are preset in the first communication device 1. One volume range is activated from the plurality of volume ranges as the reference volume range according to the decoded input instruction, the reference volume range can also be called the user's comfortable volume range. In one embodiment, the degree of hearing disability of a user or the noise of the environment are separate considerations. The volume of the second communication device 2 can be kept in the comfortable volume range by setting different volume ranges whatever the volume of the second communication device 2 before being adjusted or the degree of noise or lack of noise in the listening environment.

At block 303, volume adjustment information is transmitted to the second communication device 2 when the volume of the communication device 2 is out of the reference volume range, so as to adjust the volume of the second communication device 2. The volume adjustment information includes a volume adjustment parameter which is utilized to indicate the second communication device 2 to adjust input volume of a microphone of the second communication device 2.

In an embodiment, if the volume of the second communication device 2 is out of the reference volume range, the first communication device 1 transmits the volume adjustment information to the second communication device 2, so that the volume of the second communication device 2 can be adjusted into the reference volume range.

In an embodiment, after transmitting the volume adjustment information to the second communication device 2, the first communication device 1 determines whether the volume of the second communication device 2 is adjusted. If the first communication device 1 receives feedback information from the second communication device 2 within a preset time, then a determination is made that the first communication device 1 has adjusted the volume of the second communication device 2 by transmitting the volume adjustment information. The first communication device 1 receives the adjusted volume of the second communication device 2 which is in the reference volume range.

In another embodiment, if the first communication device 1 does not receive the feedback information within the preset time, alarm information is transmitted to the second communication device 2. The alarm information includes increasing speech volume, decreasing speech volume, speaking closer to the microphone, and speaking further away from the microphone.

In one embodiment, when determining that the received volume of the second communication device 2 is too weak, the first communication device 1 alarms the user of the second communication device 2 to increase his/her speech volume by transmitting alarm. In one embodiment, the communication device 1 can also transmit other alarm information, for example, speaking closer to the microphone. These make the volume of the second communication device 2 output increased to the range of the reference volume.

In another embodiment, when determining that the volume of the second communication device 2 is so great that it seriously decreases communication quality for the user of the first communication device 1, the first communication device 1 transmits to the second communication device 2 the alarm information to decrease volume. In one embodiment, the communication device 1 can also transmit other alarm information, for example, requesting the user of device 2 to speak further away from the microphone. These make the volume of the second communication device 2 output decreased to the range of the reference volume.

In one embodiment, when the second communication device 2 receives the alarm information, an indicator light of the second communication device 2 flashes, and the alarm information is broadcast or displayed. The alarm information informs the second communication device 2 to increase speech volume, decrease the speech volume, move closer to, or move further away from the microphone, so as to adjust the volume of the second communication device 2 within the first communication device 1.

In order to further explain the alarm information, several exemplary embodiments are described as below.

First Implementation Method:

When the volume of the second communication device 2 is low, the first communication device 1 transmits the alarm information to the second communication device 2. When the second communication device 2 receives the alarm information, the alarm information is displayed on a liquid crystal display screen of device 2.

Second Implementation Method:

When the volume of the second communication device 2 is low, the first communication device 1 transmits the alarm information to the second communication device 2. When the second communication device 2 receives the alarm information, the indicator light of device 2 flashes to warn the user to perform the volume adjustment operation.

Third Implementation Method:

When the volume of the second communication device 2 is low, the first communication device 1 transmits the alarm information to the second communication device 2. When the second communication device 2 receives the alarm information, an alarm may be heard, for example, your voice is too low, please speak louder or move closer to the microphone or telephone.

The implementation of above methods can be implemented in a single execution, a parallel execution, or an ordered execution.

The processes of adjusting the volume are only applied in the establishment of voice communication, when the voice communication is over the volume will be returned to the default value.

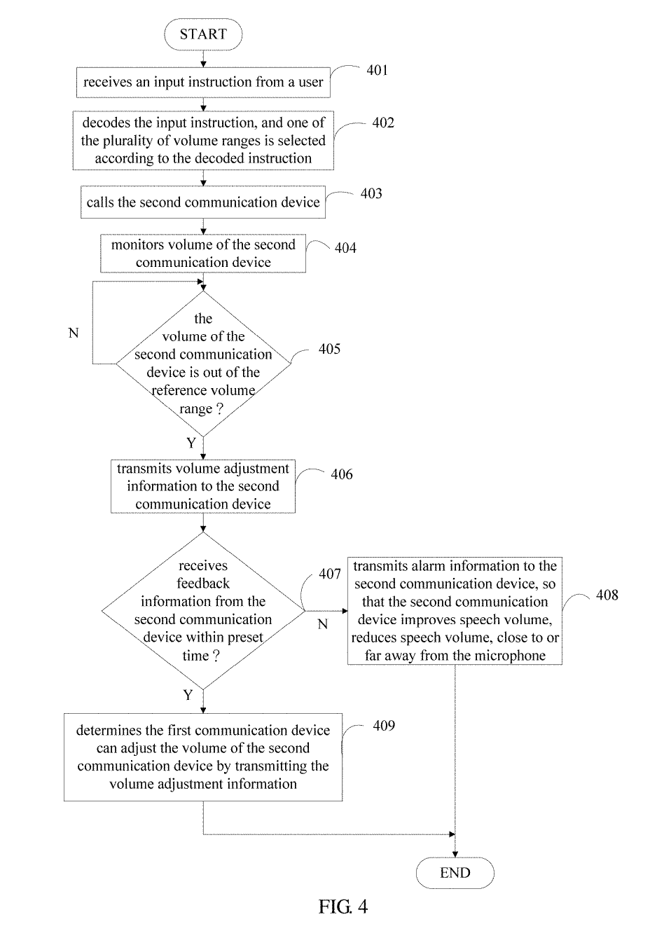

FIG. 4 illustrates a flowchart of another embodiment of volume adjustment method. In this embodiment, a first communication device 1 communicates with a second communication device 2.

At block 401, the first communication device 1 receives an input instruction from a user.

At block 402, the first communication device 1 decodes the input instruction, and activates one of the plurality of volume ranges according to the decoded input instruction.

At block 403, the first communication device 1 calls the second communication device 2.

At block 404, when the first communication device 1 is communicating with the second communication device 2, the first communication device 1 monitors volume of the second communication device 2.

At block 405, the first communication device 1 determines whether the volume of the second communication device 2 is out of the activated reference volume range. If the volume is out of the reference volume range, a block 406 is executed, or the block 405 is continues to be executed.

At block 406, the first communication device 1 transmits volume adjustment information to the second communication device 2.

At block 407, the first communication device 1 determines whether receiving feedback information from the second communication device 2 within a preset time, if the first communication device 1 does not receive the feedback information from the second communication device 2 within the preset time, a block 408 is executed, or a block 409 is executed.

At block 408, the first communication device 1 transmits alarm information to the second communication device 2, so that the second communication device 2 increases speech volume, decreases speech volume, the user of the second communication device 2 speaks closer to, or further away from a microphone.

At block 409, the first communication device 1 determines the first communication device 1 can adjust the volume of the second communication device 2 by transmitting the volume adjustment information to the second communication device 2.

The volume adjustment method and device can make the user of the first communication device 1 hear content from the second communication device 2, no matter how the volume of the second communication device 2 big or small. The volume adjustment method and device does not affect the mood of the user, this effectively improves the comfort of communication.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A volume adjustment method operable to be executed in a first communication device, wherein a reference volume range is preset for the first communication device, the method comprising:
monitoring volume of a second communication device when the first communication device is communicating with the second communication device;
determining whether the volume of the second communication device is out of the reference volume range; and
transmitting volume adjustment information to the second communication device, when the volume is out of the reference volume range, for adjusting the volume of the second communication device.

2. The volume adjustment method as claimed in claim 1, wherein a plurality of volume ranges are preset for the first communication device, further comprising:
receiving an input instruction from a user;
decoding the input instruction; and
activating one of the plurality of volume ranges as the reference volume range according to the decoded input instruction.

3. The volume adjustment method as claimed in claim 1, after the step of transmitting the volume adjustment information, further comprising:
after the first communication device transmits the volume adjustment information to the second communication device, transmitting alarm information to the second communication device if the first communication device does not receive feedback information from the second communication device within a preset time.

4. The volume adjustment method as claimed in claim 1, wherein the volume adjustment information comprises a volume adjustment parameter of a microphone.

5. The volume adjustment method as claimed in claim 3, wherein the alarm information comprises increasing speech volume, decreasing speech volume, speaking closer to the microphone, and/or speaking further away from the microphone.

6. A communication device, wherein the communication device a reference volume range is preset for the communication device, the communication device comprising:
at least one processor;
a non-transitory storage system coupled to the at least one processor and configured to store one or more programs configured to be executed by the at least one processor, the one or more programs comprising instructions for:
monitoring volume of a destination communication device when the communication device is communicating with the destination communication device;
determining whether the volume of the destination communication device is out of the reference volume range; and
transmitting volume adjustment information to the destination communication device, when the volume is out of the reference volume range, for adjusting the volume of the destination communication device.

7. The communication device as claimed in claim 6, wherein a plurality of volume ranges are preset for the communication device, the one or more programs further comprise instructions for:
receiving an input instruction from a user;
decoding the input instruction; and
activating one of the plurality of volume ranges according to the decoded input instruction.

8. The communication device as claimed in claim 6, wherein the one or more programs further comprise instructions for:
after the communication device transmits the volume adjustment information to the destination communication device, transmitting alarm information to the destination communication device if the communication device does not receive feedback information from the destination communication device within a preset time.

9. The communication device as claimed in claim 6, wherein the volume adjustment information comprises a volume adjustment parameter of a microphone.

10. The communication device as claimed in claim 8, wherein the alarm information comprises increasing speech volume, decreasing speech volume, speaking closer to the microphone, and/or speaking further away from the microphone.
